(19) United States
(12) Patent Application Publication
(10) Pub. No.: US 2023/0023202 A1
(43) Pub. Date: Jan. 26, 2023

(54) EFFICIENT RECORD FACET SEARCH BASED ON IMAGE FACETING

(71) Applicant: Ancestry. com Operations Inc., Lehi, UT (US)

(72) Inventors: Gann Bierner, Oakland, CA (US); Robert Weis, Oakland, CA (US)

(21) Appl. No.: 17/814,721

(22) Filed: Jul. 25, 2022

Related U.S. Application Data
(60) Provisional application No. 63/225,844, filed on Jul. 26, 2021.

(51) Int. Cl. G06F 16/28; G06F 16/583; G06F 16/245; G06F 16/22

(52) U.S. Cl. CPC G06F 16/285; G06F 16/583; G06F 16/245; G06F 16/2246

(57) ABSTRACT

Image-faceted search systems and/or methods are described. Image-faceting embodiments receive genealogy records certain of which are imaged genealogy records associated with an image. Metadata of the imaged genealogy records are determined or extracted and used to assign the image genealogy records to one or more categories and optionally subcategories. Machine learning may be used to extract the metadata and/or to categorize the records, along with in embodiments a translation algorithm. A user faceted search query is received, with pertinent search results filtered according to a selected facet, such as an image facet, and according to filtering criteria. The filtered search results, including images matching the faceted search query, are presented to a user.

### CROSS-REFERENCE TO RELATED APPLICATION

The present application claims the benefit of U.S. Provisional Patent Application No. 63/225,844, filed on Jul. 26, 2021, which is hereby incorporated by reference in its entirety.

### FIELD

The disclosed embodiments relate to conducting image faceting in record searches, such as genealogy records.

### BACKGROUND

Efficient and user-friendly search of large and complex databases is an outstanding problem for users and enterprises alike. As the volume, variety, and complexity of data being searched—and being returned in response to search queries—increases at an exponential rate, the need for improved search methods that allow a user to drill down on a type of records and/or results is increasingly acute.

However, while some efforts to provide, for example, faceted searching and other search methods have been tried, there remains a problem of users not being able to efficiently drill down based on the quality of results for particular purposes.

The problem of search utilities being inefficient and not user-friendly is further compounded in certain applications such as family history or genealogy applications, where billions of historical records having varying forms and contents may contain information pertinent to a search, such as a search for an ancestor's name. Most records returned in such a search for an ancestor search will be historical documents such as Census records, birth, marriage, and death certificates, and other written documents.

Comparatively few records returned in the search for an ancestor may be associated with an image of the ancestor, which may be of greatest interest to a user. At present, there is no effective way to limit the search results to results of desired images, and as such users must manually sift through hundreds or even thousands of records to view the image-related results. This can dissuade the user from even beginning to sift through the results to find meaningful results, and may discourage the user from searching altogether. Even image-specific searches do not provide a way to drill down to a particular type of image across all different types of records without having to perform intensive and repetitive searches across specific collections of images.

### SUMMARY

Disclosed herein relates to example embodiments of a computer-implemented method. The computer-implemented method may include receiving a plurality of genealogy records. One or more genealogy records may be imaged genealogy records that are each associated with an image. The computer-implemented method may include determining metadata associated with the imaged genealogy records. The computer-implemented method may include assigning the imaged genealogy records to one or more categories based on the images and the metadata associated with the imaged genealogy records. The computer-implemented method may include receiving a user facet query that searches for genealogy records based on one or more filtering criteria related to images. The computer-implemented method may include filtering the plurality of genealogy records by applying the filtering criteria to the categories associated with the imaged genealogy records. The computer-implemented method may include presenting filtered genealogy records with the images that match the one or more filtering criteria as a response to the user facet query.

In some embodiments, the techniques described herein relate to a computer-implemented method, wherein the metadata associated with the imaged genealogy records are data that are inherent in the genealogy records.

In some embodiments, the metadata associated with the imaged genealogy records are image features that are extracted by a machine learning model.

In some embodiments, assigning the imaged genealogy records to one or more categories includes applying a machine learning model to classify the image associated with the imaged genealogy records.

In some embodiments, the machine learning model includes a convolutional neural network.

In some embodiments, assigning the imaged genealogy records to one or more categories includes applying a translation algorithm.

In some embodiments, assigning the imaged genealogy records to one or more categories is based on one or more image facets, each facet associated with a characteristic of the image associated with an imaged genealogy record.

In some embodiments, assigning the imaged genealogy records to one or more categories includes assigning the imaged genealogy records with one or more category tags, wherein a category tag indicates that a record belongs to a category or a subcategory.

In some embodiments, the plurality of genealogy records includes individual records, tombstone records, document records, and community records.

In yet another embodiment, a non-transitory computer-readable medium that is configured to store instructions is described. The instructions, when executed by one or more processors, cause the one or more processors to perform a process that includes steps described in the above computer-implemented methods or described in any embodiments of this disclosure. In yet another embodiment, a system may include one or more processors and a storage medium that is configured to store instructions. The instructions, when executed by one or more processors, cause the one or more processors to perform a process that includes steps described in the above computer-implemented methods or described in any embodiments of this disclosure.

### BRIEF DESCRIPTION OF THE DRAWINGS

Figure (FIG. 1 illustrates a diagram of a system environment of an example computing system, in accordance with some embodiments.

FIG. 2 is a block diagram of an architecture of an example computing system, in accordance with some embodiments.

FIG. 3 is a flowchart depicting an example process 300 for providing a record facet search based on image faceting, in accordance with some embodiments.

FIG. 4 depicts a search interface with results unfiltered using image faceting, in accordance with some embodiments.

FIG. 5 depicts a search interface with results filtered using image faceting based on people, in accordance with some embodiments.

FIG. 6 depicts a search interface with results filtered using image faceting based on resting places, in accordance with some embodiments.

FIG. 7 depicts a search interface with results filtered using image faceting based on documents, in accordance with some embodiments.

FIG. 8 depicts a search interface with results filtered using image faceting based on community and geography, in accordance with some embodiments.

FIG. 9A depicts a search interface with results filtered using image faceting based on transportation and travel, in accordance with some embodiments.

FIG. 9B depicts a search interface with results filtered using image faceting based on family symbols and art, in accordance with some embodiments.

FIG. 10 is a block diagram of an example computing device, in accordance with some embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The figures (FIGs.) and the following description relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Various approaches in conducting data record search using image faceting advantageously address problems in the art by providing an intuitive and effective search utility that users can apply to filter search results based on quality or desired attributes for certain purposes. For example, users in a genealogy service may wish to view and sort by only results having or associated with images. However, faceting according to images in such a service may be difficult given the volume of records (numbering in some enterprises in the tens of billions) and the difficulty of accurately and automatically assessing whether images actually pertain to a searched entity, such as a user's ancestor. The need for providing users with accurate results is likewise paramount.

Various embodiments described herein advantageously allow for providing image-based results upon a user selecting an image subject as a search facet. The image subject search facet includes multiple possible categorizations, including people, objects of interest, places of interest, or otherwise. For instance, the image subject search facet may allow the user to drill down in the query results specifically on people (as opposed to, say, objects or places), and further on images of groups versus images of individuals, e.g. a single person.

Various embodiments further advantageously provide a number of results next to the image subject search facets. For example, a user, upon searching a particular name or another query, can see that drilling down on people>groups will return a certain number of results, whereas drilling down people>individuals will return another number of results. This allows for improved and more-efficient searching by the user as the user is able to discern the likely success or results of a particular faceting operation. In some embodiments, upon selecting a particular image subject search facet such as people>groups, the search results initially returned based on the query, which may number in the hundreds or thousands, are filtered such that only those results with images of groups remain. These results may remain in the order of relevance initially determined in the unfaceted search results. In some embodiments, the order of results may be re-determined upon applying the image subject search facet.

Image faceting embodiments address shortcomings in the art by facilitating a focused search by a user of specific categories of image-containing search results. Whereas an unfaceted search query on a database, such as for an ancestor's name in a family history service database, may return millions of results, faceting by image according to various embodiments may reduce the number of results that a user must sift through by orders of magnitude and provide a more engaging, intuitive, and effective search modality.

The image faceting embodiments advantageously allow for metadata of an image, such as labels applied by a classification machine learning model, to be appropriately consolidated into predetermined categories and optionally subcategories according to which a user may facet a search. The number of results pertaining to the categories and subcategories may be displayed to guide a user to the most-promising facet or otherwise to help facilitate an efficient search.

### Example System Environment

FIG. 1 illustrates a diagram of a system environment 100 of an example computing server 130, in accordance with some embodiments. The system environment 100 shown in FIG. 1 includes one or more client devices 110, a network 120, a genetic data extraction service server 125, and a computing server 130. In various embodiments, the system environment 100 may include fewer or additional components. The system environment 100 may also include different components.

The client devices 110 are one or more computing devices capable of receiving user input as well as transmitting and/or receiving data via a network 120. Example computing devices include desktop computers, laptop computers, personal digital assistants (PDAs), smartphones, tablets, wearable electronic devices (e.g., smartwatches), smart household appliances (e.g., smart televisions, smart speakers, smart home hubs), Internet of Things (IoT) devices or other suitable electronic devices. A client device 110 communicates to other components via the network 120. Users may be customers of the computing server 130 or any individuals who access the system of the computing server 130, such as an online website or a mobile application. In some embodiments, a client device 110 executes an application that launches a graphical user interface (GUI) for a user of the client device 110 to interact with the computing server 130. The GUI may be an example of a user interface 115. A client device 110 may also execute a web browser application to enable interactions between the client device 110 and the computing server 130 via the network 120. In another embodiment, the user interface 115 may take the form of a software application published by the computing server 130 and installed on the user device 110. In yet another embodiment, a client device 110 interacts with the computing server 130 through an application programming interface (API) running on a native operating system of the client device 110, such as IOS or ANDROID.

The network 120 provides connections to the components of the system environment 100 through one or more sub-networks, which may include any combination of local area and/or wide area networks, using both wired and/or wireless communication systems. In some embodiments, a network 120 uses standard communications technologies and/or protocols. For example, a network 120 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 120 may be represented using any suitable format, such as hypertext markup language (HTML) or extensible markup language (XML). In some embodiments, all or some of the communication links of a network 120 may be encrypted using any suitable technique or techniques such as secure sockets layer (SSL), transport layer security (TLS), virtual private networks (VPNs), Internet Protocol security (IPsec), etc. The network 120 also includes links and packet switching networks such as the Internet.

Individuals, who may be customers of a company operating the computing server 130, provide biological samples for analysis of their genetic data. Individuals may also be referred to as users. In some embodiments, an individual uses a sample collection kit to provide a biological sample (e.g., saliva, blood, hair, tissue) from which genetic data is extracted and determined according to nucleotide processing techniques such as amplification and sequencing. Amplification may include using polymerase chain reaction (PCR) to amplify segments of nucleotide samples. Sequencing may include sequencing of deoxyribonucleic acid (DNA) sequencing, ribonucleic acid (RNA) sequencing, etc. Suitable sequencing techniques may include Sanger sequencing and massively parallel sequencing such as various next-generation sequencing (NGS) techniques including whole genome sequencing, pyrosequencing, sequencing by synthesis, sequencing by ligation, and ion semiconductor sequencing. In some embodiments, a set of SNPs (e.g., 300,000) that are shared between different array platforms (e.g., Illumina OmniExpress Platform and Illumina HumanHap 650Y Platform) may be obtained as genetic data. Genetic data extraction service server 125 receives biological samples from users of the computing server 130. The genetic data extraction service server 125 performs sequencing of the biological samples and determines the base pair sequences of the individuals. The genetic data extraction service server 125 generates the genetic data of the individuals based on the sequencing results. The genetic data may include data sequenced from DNA or RNA and may include base pairs from coding and/or noncoding regions of DNA.

The genetic data may take different forms and include information regarding various biomarkers of an individual. For example, in some embodiments, the genetic data may be the base pair sequence of an individual. The base pair sequence may include the whole genome or a part of the genome such as certain genetic loci of interest. In another embodiment, the genetic data extraction service server 125 may determine genotypes from sequencing results, for example by identifying genotype values of single nucleotide polymorphisms (SNPs) present within the DNA. The results in this example may include a sequence of genotypes corresponding to various SNP sites. A SNP site may also be referred to as a SNP loci. A genetic locus is a segment of a genetic sequence. A locus can be a single site or a longer stretch. The segment can be a single base long or multiple bases long. In some embodiments, the genetic data extraction service server 125 may perform data pre-processing of the genetic data to convert raw sequences of base pairs to sequences of genotypes at target SNP sites. Since a typical human genome may differ from a reference human genome at only several million SNP sites (as opposed to billions of base pairs in the whole genome), the genetic data extraction service server 125 may extract only the genotypes at a set of target SNP sites and transmit the extracted data to the computing server 130 as the genetic dataset of an individual. SNPs, base pair sequence, genotype, haplotype, RNA sequences, protein sequences, and phenotypes are examples of biomarkers.

The computing server 130 performs various analyses of the genetic data, genealogy data, and users' survey responses to generate results regarding the phenotypes and genealogy of users of computing server 130. Depending on the embodiments, the computing server 130 may also be referred to as an online server, a personal genetic service server, a genealogy server, a family tree building server, and/or a social networking system. The computing server 130 receives genetic data from the genetic data extraction service server 125 and stores the genetic data in the data store of the computing server 130. The computing server 130 may analyze the data to generate results regarding the genetics or genealogy of users. The results regarding the genetics or genealogy of users may include the ethnicity compositions of users, paternal and maternal genetic analysis, identification or suggestion of potential family relatives, ancestor information, analyses of DNA data, potential or identified traits such as phenotypes of users (e.g., diseases, appearance traits, other genetic characteristics, and other non-genetic characteristics including social characteristics), etc. The computing server 130 may present or cause the user interface 115 to present the results to the users through a GUI displayed at the client device 110. The results may include graphical elements, textual information, data, charts, and other elements such as family trees.

In some embodiments, the computing server 130 also allows various users to create one or more genealogical profiles of the user. The genealogical profile may include a list of individuals (e.g., ancestors, relatives, friends, and other people of interest) who are added or selected by the user or suggested by the computing server 130 based on the genealogy records and/or genetic records. The user interface 115 controlled by or in communication with the computing server 130 may display the individuals in a list or as a family tree such as in the form of a pedigree chart. In some embodiments, subject to user's privacy setting and authorization, the computing server 130 may allow information generated from the user's genetic dataset to be linked to the user profile and to one or more of the family trees. The users may also authorize the computing server 130 to analyze their genetic dataset and allow their profiles to be discovered by other users.

### Example Computing Server Architecture

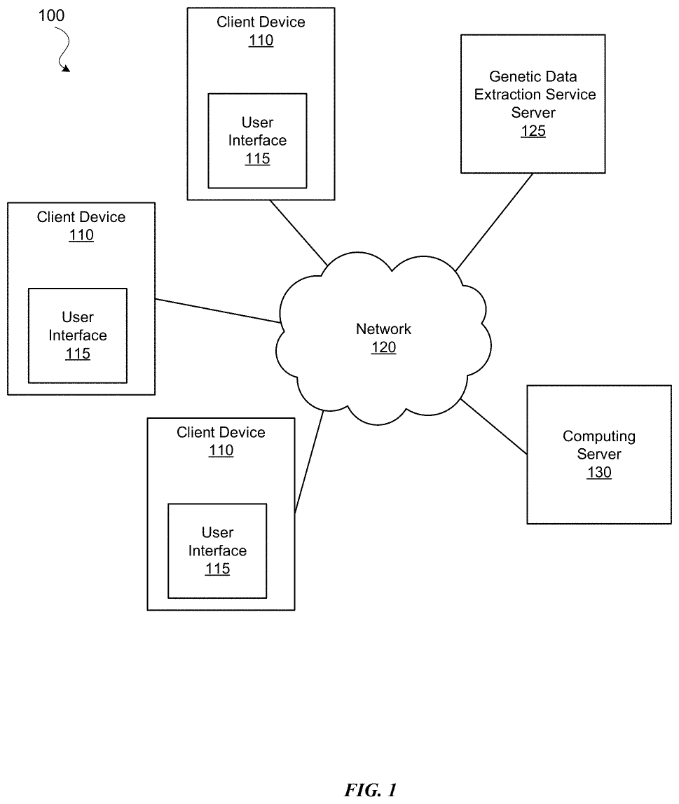

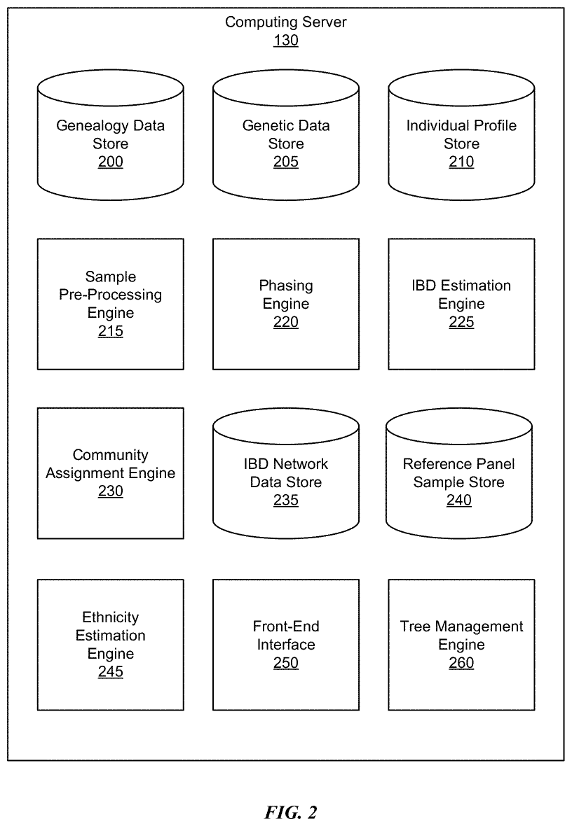

FIG. 2 is a block diagram of an architecture of an example computing server 130, in accordance with some embodiments. In the embodiment shown in FIG. 2, the computing server 130 includes a genealogy data store 200, a genetic data store 205, an individual profile store 210, a sample pre-processing engine 215, a phasing engine 220, an identity by descent (IBD) estimation engine 225, a community assignment engine 230, an IBD network data store 235, a reference panel sample store 240, an ethnicity estimation engine 245, and a front-end interface 250. The functions of the computing server 130 may be distributed among the elements in a different manner than described. In various embodiments, the computing server 130 may include different components and fewer or additional components. Each of the various data stores may be a single storage device, a server controlling multiple storage devices, or a distributed network that is accessible through multiple nodes (e.g., a cloud storage system).

The computing server 130 stores various data of different individuals, including genetic data, genealogy data, and survey response data. The computing server 130 processes the genetic data of users to identify shared identity-by-descent (IBD) segments between individuals. The genealogy data and survey response data may be part of user profile data. The amount and type of user profile data stored for each user may vary based on the information of a user, which is provided by the user as she creates an account and profile at a system operated by the computing server 130 and continues to build her profile, family tree, and social network at the system and to link her profile with her genetic data. Users may provide data via the user interface 115 of a client device 110. Initially and as a user continues to build her genealogical profile, the user may be prompted to answer questions related to the basic information of the user (e.g., name, date of birth, birthplace, etc.) and later on more advanced questions that may be useful for obtaining additional genealogy data. The computing server 130 may also include survey questions regarding various traits of the users such as the users' phenotypes, characteristics, preferences, habits, lifestyle, environment, etc.

Genealogy data may be stored in the genealogy data store 200 and may include various types of data that are related to tracing family relatives of users. Examples of genealogy data include names (first, last, middle, suffixes), gender, birth locations, date of birth, date of death, marriage information, spouse's information kinships, family history, dates and places for life events (e.g., birth and death), other vital data, and the like. In some instances, family history can take the form of a pedigree of an individual (e.g., the recorded relationships in the family). The family tree information associated with an individual may include one or more specified nodes. Each node in the family tree represents the individual, an ancestor of the individual who might have passed down genetic material to the individual, and the individual's other relatives including siblings, cousins, and offspring in some cases. Genealogy data may also include connections and relationships among users of the computing server 130. The information related to the connections among a user and her relatives that may be associated with a family tree may also be referred to as pedigree data or family tree data.

In addition to user-input data, genealogy data may also take other forms that are obtained from various sources such as public records and third-party data collectors. For example, genealogy records from public sources include birth records, marriage records, death records, census records, court records, probate records, adoption records, obituary records, etc. Likewise, genealogy data may include data from one or more family trees of an individual, the Ancestry World Tree system, a Social Security Death Index database, the World Family Tree system, a birth certificate database, a death certificate database, a marriage certificate database, an adoption database, a draft registration database, a veterans database, a military database, a property records database, a census database, a voter registration database, a phone database, an address database, a newspaper database, an immigration database, a family history records database, a local history records database, a business registration database, a motor vehicle database, and the like.

Furthermore, the genealogy data store 200 may also include relationship information inferred from the genetic data stored in the genetic data store 205 and information received from the individuals. For example, the relationship information may indicate which individuals are genetically related, how they are related, how many generations back they share common ancestors, lengths and locations of IBD segments shared, which genetic communities an individual is a part of, variants carried by the individual, and the like.

The computing server 130 maintains genetic datasets of individuals in the genetic data store 205. A genetic dataset of an individual may be a digital dataset of nucleotide data (e.g., SNP data) and corresponding metadata. A genetic dataset may contain data on the whole or portions of an individual's genome. The genetic data store 205 may store a pointer to a location associated with the genealogy data store 200 associated with the individual. A genetic dataset may take different forms. In some embodiments, a genetic dataset may take the form of a base pair sequence of the sequencing result of an individual. A base pair sequence dataset may include the whole genome of the individual (e.g., obtained from a whole-genome sequencing) or some parts of the genome (e.g., genetic loci of interest).

In another embodiment, a genetic dataset may take the form of sequences of genetic markers. Examples of genetic markers may include target SNP loci (e.g., allele sites) filtered from the sequencing results. A SNP locus that is single base pair long may also be referred to a SNP site. A SNP locus may be associated with a unique identifier. The genetic dataset may be in a form of diploid data that includes a sequencing of genotypes, such as genotypes at the target SNP loci, or the whole base pair sequence that includes genotypes at known SNP loci and other base pair sites that are not commonly associated with known SNPs. The diploid dataset may be referred to as a genotype dataset or a genotype sequence. Genotype may have a different meaning in various contexts. In one context, an individual's genotype may refer to a collection of diploid alleles of an individual. In other contexts, a genotype may be a pair of alleles present on two chromosomes for an individual at a given genetic marker such as a SNP site.

Genotype data for a SNP site may include a pair of alleles. The pair of alleles may be homozygous (e.g., A-A or G-G) or heterozygous (e.g., A-T, C-T). Instead of storing the actual nucleotides, the genetic data store 205 may store genetic data that are converted to bits. For a given SNP site, oftentimes only two nucleotide alleles (instead of all 4) are observed. As such, a 2-bit number may represent a SNP site. For example, 00 may represent homozygous first alleles, 11 may represent homozygous second alleles, and 01 or 10 may represent heterozygous alleles. A separate library may store what nucleotide corresponds to the first allele and what nucleotide corresponds to the second allele at a given SNP site.

A diploid dataset may also be phased into two sets of haploid data, one corresponding to a first parent side and another corresponding to a second parent side. The phased datasets may be referred to as haplotype datasets or haplotype sequences. Similar to genotype, haplotype may have a different meaning in various contexts. In one context, a haplotype may also refer to a collection of alleles that corresponds to a genetic segment. In other contexts, a haplotype may refer to a specific allele at a SNP site. For example, a sequence of haplotypes may refer to a sequence of alleles of an individual that are inherited from a parent.

The individual profile store 210 stores profiles and related metadata associated with various individuals appeared in the computing server 130. A computing server 130 may use unique individual identifiers to identify various users and other non-users that might appear in other data sources such as ancestors or historical persons who appear in any family tree or genealogy database. A unique individual identifier may be a hash of certain identification information of an individual, such as a user's account name, user's name, date of birth, location of birth, or any suitable combination of the information. The profile data related to an individual may be stored as metadata associated with an individual's profile. For example, the unique individual identifier and the metadata may be stored as a key-value pair using the unique individual identifier as a key.

An individual's profile data may include various kinds of information related to the individual. The metadata about the individual may include one or more pointers associating genetic datasets such as genotype and phased haplotype data of the individual that are saved in the genetic data store 205. The metadata about the individual may also be individual information related to family trees and pedigree datasets that include the individual. The profile data may further include declarative information about the user that was authorized by the user to be shared and may also include information inferred by the computing server 130. Other examples of information stored in a user profile may include biographic, demographic, and other types of descriptive information such as work experience, educational history, gender, hobbies, or preferences, location and the like. In some embodiments, the user profile data may also include one or more photos of the users and photos of relatives (e.g., ancestors) of the users that are uploaded by the users. A user may authorize the computing server 130 to analyze one or more photos to extract information, such as the user's or relative's appearance traits (e.g., blue eyes, curved hair, etc.), from the photos. The appearance traits and other information extracted from the photos may also be saved in the profile store. In some cases, the computing server may allow users to upload many different photos of the users, their relatives, and even friends. User profile data may also be obtained from other suitable sources, including historical records (e.g., records related to an ancestor), medical records, military records, photographs, other records indicating one or more traits, and other suitable recorded data.

For example, the computing server 130 may present various survey questions to its users from time to time. The responses to the survey questions may be stored at individual profile store 210. The survey questions may be related to various aspects of the users and the users' families. Some survey questions may be related to users' phenotypes, while other questions may be related to environmental factors of the users.

Survey questions may concern health or disease-related phenotypes, such as questions related to the presence or absence of genetic diseases or disorders, inheritable diseases or disorders, or other common diseases or disorders that have a family history as one of the risk factors, questions regarding any diagnosis of increased risk of any diseases or disorders, and questions concerning wellness-related issues such as a family history of obesity, family history of causes of death, etc. The diseases identified by the survey questions may be related to single-gene diseases or disorders that are caused by a single-nucleotide variant, an insertion, or a deletion. The diseases identified by the survey questions may also be multifactorial inheritance disorders that may be caused by a combination of environmental factors and genes. Examples of multifactorial inheritance disorders may include heart disease, Alzheimer's disease, diabetes, cancer, and obesity. The computing server 130 may obtain data on a user's disease-related phenotypes from survey questions about the health history of the user and her family and also from health records uploaded by the user.

Survey questions also may be related to other types of phenotypes such as appearance traits of the users. A survey regarding appearance traits and characteristics may include questions related to eye color, iris pattern, freckles, chin types, finger length, dimple chin, earlobe types, hair color, hair curl, skin pigmentation, susceptibility to skin burn, bitter taste, male baldness, baldness pattern, presence of unibrow, presence of wisdom teeth, height, and weight. A survey regarding other traits also may include questions related to users' taste and smell such as the ability to taste bitterness, asparagus smell, cilantro aversion, etc. A survey regarding traits may further include questions related to users' body conditions such as lactose tolerance, caffeine consumption, malaria resistance, norovirus resistance, muscle performance, alcohol flush, etc. Other survey questions regarding a person's physiological or psychological traits may include vitamin traits and sensory traits such as the ability to sense an asparagus metabolite. Traits may also be collected from historical records, electronic health records and electronic medical records.

The computing server 130 also may present various survey questions related to the environmental factors of users. In this context, an environmental factor may be a factor that is not directly connected to the genetics of the users. Environmental factors may include users' preferences, habits, and lifestyles. For example, a survey regarding users' preferences may include questions related to things and activities that users like or dislike, such as types of music a user enjoys, dancing preference, party-going preference, certain sports that a user plays, video game preferences, etc. Other questions may be related to the users' diet preferences such as like or dislike a certain type of food (e.g., ice cream, egg). A survey related to habits and lifestyle may include questions regarding smoking habits, alcohol consumption and frequency, daily exercise duration, sleeping habits (e.g., morning person versus night person), sleeping cycles and problems, hobbies, and travel preferences. Additional environmental factors may include diet amount (calories, macronutrients), physical fitness abilities (e.g. stretching, flexibility, heart rate recovery), family type (adopted family or not, has siblings or not, lived with extended family during childhood), property and item ownership (has home or rents, has a smartphone or doesn't, has a car or doesn't).

Surveys also may be related to other environmental factors such as geographical, social-economic, or cultural factors. Geographical questions may include questions related to the birth location, family migration history, town, or city of users' current or past residence. Social-economic questions may be related to users' education level, income, occupations, self-identified demographic groups, etc. Questions related to culture may concern users' native language, language spoken at home, customs, dietary practices, etc. Other questions related to users' cultural and behavioral questions are also possible.

For any survey questions asked, the computing server 130 may also ask an individual the same or similar questions regarding the traits and environmental factors of the ancestors, family members, other relatives or friends of the individual. For example, a user may be asked about the native language of the user and the native languages of the user's parents and grandparents. A user may also be asked about the health history of his or her family members.

In addition to storing the survey data in the individual profile store 210, the computing server 130 may store some responses that correspond to data related to genealogical and genetics respectively to genealogy data store 200 and genetic data store 205.

The user profile data, photos of users, survey response data, the genetic data, and the genealogy data may be subject to the privacy and authorization setting of the users to specify any data related to the users that can be accessed, stored, obtained, or otherwise used. For example, when presented with a survey question, a user may select to answer or skip the question. The computing server 130 may present users from time to time information regarding users' selection of the extent of information and data shared. The computing server 130 also may maintain and enforce one or more privacy settings for users in connection with the access of the user profile data, photos, genetic data, and other sensitive data. For example, the user may pre-authorize the access to the data and may change the setting as wished. The privacy settings also may allow a user to specify (e.g., by opting out, by not opting in) whether the computing server 130 may receive, collect, log, or store particular data associated with the user for any purpose. A user may restrict her data at various levels. For example, on one level, the data may not be accessed by the computing server 130 for purposes other than displaying the data in the user's own profile. On another level, the user may authorize anonymization of her data and participate in studies and researches conducted by the computing server 130 such as a large-scale genetic study. On yet another level, the user may turn some portions of her genealogy data public to allow the user to be discovered by other users (e.g., potential relatives) and be connected to one or more family trees. Access or sharing of any information or data in the computing server 130 may also be subject to one or more similar privacy policies. A user's data and content objects in the computing server 130 may also be associated with different levels of restriction. The computing server 130 may also provide various notification features to inform and remind users of their privacy and access settings. For example, when privacy settings for a data entry allow a particular user or other entities to access the data, the data may be described as being “visible,” “public,” or other suitable labels, contrary to a “private” label.

In some cases, the computing server 130 may have a heightened privacy protection on certain types of data and data related to certain vulnerable groups. In some cases, the heightened privacy settings may strictly prohibit the use, analysis, and sharing of data related to a certain vulnerable group. In other cases, the heightened privacy settings may specify that data subject to those settings require prior approval for access, publication, or other use. In some cases, the computing server 130 may provide the heightened privacy as a default setting for certain types of data, such as genetic data or any data that the user marks as sensitive. The user may opt in to sharing of those data or change the default privacy settings. In other cases, the heightened privacy settings may apply across the board for all data of certain groups of users. For example, if computing server 130 determines that the user is a minor or has recognized that a picture of a minor is uploaded, the computing server 130 may designate all profile data associated with the minor as sensitive. In those cases, the computing server 130 may have one or more extra steps in seeking and confirming any sharing or use of the sensitive data.

The sample pre-processing engine 215 receives and pre-processes data received from various sources to change the data into a format used by the computing server 130. For genealogy data, the sample pre-processing engine 215 may receive data from an individual via the user interface 115 of the client device 110. To collect the user data (e.g., genealogical and survey data), the computing server 130 may cause an interactive user interface on the client device 110 to display interface elements in which users can provide genealogy data and survey data. Additional data may be obtained from scans of public records. The data may be manually provided or automatically extracted via, for example, optical character recognition (OCR) performed on census records, town or government records, or any other item of printed or online material. Some records may be obtained by digitalizing written records such as older census records, birth certificates, death certificates, etc.

The sample pre-processing engine 215 may also receive raw data from genetic data extraction service server 125. The genetic data extraction service server 125 may perform laboratory analysis of biological samples of users and generate sequencing results in the form of digital data. The sample pre-processing engine 215 may receive the raw genetic datasets from the genetic data extraction service server 125. The human genome mutation rate is estimated to be 1.1*10\hat{ }-8 per site per generation. This may lead to a variant of approximately every 300 base pairs. Most of the mutations that are passed down to descendants are related to single-nucleotide polymorphism (SNP). SNP is a substitution of a single nucleotide that occurs at a specific position in the genome. The sample pre-processing engine 215 may convert the raw base pair sequence into a sequence of genotypes of target SNP sites. Alternatively, the pre-processing of this conversion may be performed by the genetic data extraction service server 125. The sample pre-processing engine 215 identifies autosomal SNPs in an individual's genetic dataset. In some embodiments, the SNPs may be autosomal SNPs. In some embodiments, 700,000 SNPs may be identified in an individual's data and may be stored in genetic data store 205. Alternatively, in some embodiments, a genetic dataset may include at least 10,000 SNP sites. In another embodiment, a genetic dataset may include at least 100,000 SNP sites. In yet another embodiment, a genetic dataset may include at least 300,000 SNP sites. In yet another embodiment, a genetic dataset may include at least 1,000,000 SNP sites. The sample pre-processing engine 215 may also convert the nucleotides into bits. The identified SNPs, in bits or in other suitable formats, may be provided to the phasing engine 220 which phases the individual's diploid genotypes to generate a pair of haplotypes for each user.

The phasing engine 220 phases diploid genetic dataset into a pair of haploid genetic datasets and may perform imputation of SNP values at certain sites whose alleles are missing. An individual's haplotype may refer to a collection of alleles (e.g., a sequence of alleles) that are inherited from a parent.

Phasing may include a process of determining the assignment of alleles (particularly heterozygous alleles) to chromosomes. Owing to sequencing conditions and other constraints, a sequencing result often includes data regarding a pair of alleles at a given SNP locus of a pair of chromosomes but may not be able to distinguish which allele belongs to which specific chromosome. The phasing engine 220 uses a genotype phasing algorithm to assign one allele to a first chromosome and another allele to another chromosome. The genotype phasing algorithm may be developed based on an assumption of linkage disequilibrium (LD), which states that haplotype in the form of a sequence of alleles tends to cluster together. The phasing engine 220 is configured to generate phased sequences that are also commonly observed in many other samples. Put differently, haplotype sequences of different individuals tend to cluster together. A haplotype-cluster model may be generated to determine the probability distribution of a haplotype that includes a sequence of alleles. The haplotype-cluster model may be trained based on labeled data that includes known phased haplotypes from a trio (parents and a child). A trio is used as a training sample because the correct phasing of the child is almost certain by comparing the child's genotypes to the parent's genetic datasets. The haplotype-cluster model may be generated iteratively along with the phasing process with a large number of unphased genotype datasets. The haplotype-cluster model may also be used to impute one or more missing data.

By way of example, the phasing engine 220 may use a directed acyclic graph model such as a hidden Markov model (HMM) to perform the phasing of a target genotype dataset. The directed acyclic graph may include multiple levels, each level having multiple nodes representing different possibilities of haplotype clusters. An emission probability of a node, which may represent the probability of having a particular haplotype cluster given an observation of the genotypes may be determined based on the probability distribution of the haplotype-cluster model. A transition probability from one node to another may be initially assigned to a non-zero value and be adjusted as the directed acyclic graph model and the haplotype-cluster model are trained. Various paths are possible in traversing different levels of the directed acyclic graph model. The phasing engine 220 determines a statistically likely path, such as the most probable path or a probable path that is at least more likely than 95% of other possible paths, based on the transition probabilities and the emission probabilities. A suitable dynamic programming algorithm such as the Viterbi algorithm may be used to determine the path. The determined path may represent the phasing result. U.S. Pat. No. 10,679,729, entitled “Haplotype Phasing Models,” granted on Jun. 9, 2020, describes example embodiments of haplotype phasing.

The IBD estimation engine 225 estimates the amount of shared genetic segments between a pair of individuals based on phased genotype data (e.g., haplotype datasets) that are stored in the genetic data store 205. IBD segments may be segments identified in a pair of individuals that are putatively determined to be inherited from a common ancestor. The IBD estimation engine 225 retrieves a pair of haplotype datasets for each individual. The IBD estimation engine 225 may divide each haplotype dataset sequence into a plurality of windows. Each window may include a fixed number of SNP sites (e.g., about 100 SNP sites). The IBD estimation engine 225 identifies one or more seed windows in which the alleles at all SNP sites in at least one of the phased haplotypes between two individuals are identical. The IBD estimation engine 225 may expand the match from the seed windows to nearby windows until the matched windows reach the end of a chromosome or until a homozygous mismatch is found, which indicates the mismatch is not attributable to potential errors in phasing or imputation. The IBD estimation engine 225 determines the total length of matched segments, which may also be referred to as IBD segments. The length may be measured in the genetic distance in the unit of centimorgans (cM). A unit of centimorgan may be a genetic length. For example, two genomic positions that are one cM apart may have a 1% chance during each meiosis of experiencing a recombination event between the two positions. The computing server 130 may save data regarding individual pairs who share a length of IBD segments exceeding a predetermined threshold (e.g., 6 cM), in a suitable data store such as in the genealogy data store 200. U.S. Pat. No. 10,114,922, entitled “Identifying Ancestral Relationships Using a Continuous stream of Input,” granted on Oct. 30, 2018, and U.S. Pat. No. 10,720,229, entitled “Reducing Error in Predicted Genetic Relationships,” granted on Jul. 21, 2020, describe example embodiments of IBD estimation.

Typically, individuals who are closely related share a relatively large number of IBD segments, and the IBD segments tend to have longer lengths (individually or in aggregate across one or more chromosomes). In contrast, individuals who are more distantly related share relatively fewer IBD segments, and these segments tend to be shorter (individually or in aggregate across one or more chromosomes). For example, while close family members often share upwards of 71 cM of IBD (e.g., third cousins), more distantly related individuals may share less than 12 cM of IBD. The extent of relatedness in terms of IBD segments between two individuals may be referred to as IBD affinity. For example, the IBD affinity may be measured in terms of the length of IBD segments shared between two individuals.

Community assignment engine 230 assigns individuals to one or more genetic communities based on the genetic data of the individuals. A genetic community may correspond to an ethnic origin or a group of people descended from a common ancestor. The granularity of genetic community classification may vary depending on embodiments and methods used to assign communities. For example, in some embodiments, the communities may be African, Asian, European, etc. In another embodiment, the European community may be divided into Irish, German, Swedes, etc. In yet another embodiment, the Irish may be further divided into Irish in Ireland, Irish immigrated to America in 1800, Irish immigrated to America in 1900, etc. The community classification may also depend on whether a population is admixed or unadmixed. For an admixed population, the classification may further be divided based on different ethnic origins in a geographical region.

Community assignment engine 230 may assign individuals to one or more genetic communities based on their genetic datasets using machine learning models trained by unsupervised learning or supervised learning. In an unsupervised approach, the community assignment engine 230 may generate data representing a partially connected undirected graph. In this approach, the community assignment engine 230 represents individuals as nodes. Some nodes are connected by edges whose weights are based on IBD affinity between two individuals represented by the nodes. For example, if the total length of two individuals' shared IBD segments does not exceed a predetermined threshold, the nodes are not connected. The edges connecting two nodes are associated with weights that are measured based on the IBD affinities. The undirected graph may be referred to as an IBD network. The community assignment engine 230 uses clustering techniques such as modularity measurement (e.g., the Louvain method) to classify nodes into different clusters in the IBD network. Each cluster may represent a community. The community assignment engine 230 may also determine sub-clusters, which represent sub-communities. The computing server 130 saves the data representing the IBD network and clusters in the IBD network data store 235. U.S. Pat. No. 10,223,498, entitled “Discovering Population Structure from Patterns of Identity-By-Descent,” granted on Mar. 5, 2019, describes example embodiments of community detection and assignment.

The community assignment engine 230 may also assign communities using supervised techniques. For example, genetic datasets of known genetic communities (e.g., individuals with confirmed ethnic origins) may be used as training sets that have labels of the genetic communities. Supervised machine learning classifiers, such as logistic regressions, support vector machines, random forest classifiers, and neural networks may be trained using the training set with labels. A trained classifier may distinguish binary or multiple classes. For example, a binary classifier may be trained for each community of interest to determine whether a target individual's genetic dataset belongs or does not belong to the community of interest. A multi-class classifier such as a neural network may also be trained to determine whether the target individual's genetic dataset most likely belongs to one of several possible genetic communities.

Reference panel sample store 240 stores reference panel samples for different genetic communities. A reference panel sample is a genetic data of an individual whose genetic data is the most representative of a genetic community. The genetic data of individuals with the typical alleles of a genetic community may serve as reference panel samples. For example, some alleles of genes may be over-represented (e.g., being highly common) in a genetic community. Some genetic datasets include alleles that are commonly present among members of the community. Reference panel samples may be used to train various machine learning models in classifying whether a target genetic dataset belongs to a community, determining the ethnic composition of an individual, and determining the accuracy of any genetic data analysis, such as by computing a posterior probability of a classification result from a classifier.

A reference panel sample may be identified in different ways. In some embodiments, an unsupervised approach in community detection may apply the clustering algorithm recursively for each identified cluster until the sub-clusters contain a number of nodes that are smaller than a threshold (e.g., contains fewer than 1000 nodes). For example, the community assignment engine 230 may construct a full IBD network that includes a set of individuals represented by nodes and generate communities using clustering techniques. The community assignment engine 230 may randomly sample a subset of nodes to generate a sampled IBD network. The community assignment engine 230 may recursively apply clustering techniques to generate communities in the sampled IBD network. The sampling and clustering may be repeated for different randomly generated sampled IBD networks for various runs. Nodes that are consistently assigned to the same genetic community when sampled in various runs may be classified as a reference panel sample. The community assignment engine 230 may measure the consistency in terms of a predetermined threshold. For example, if a node is classified to the same community 95% (or another suitable threshold) of the times whenever the node is sampled, the genetic dataset corresponding to the individual represented by the node may be regarded as a reference panel sample. Additionally, or alternatively, the community assignment engine 230 may select N most consistently assigned nodes as a reference panel for the community.

Other ways to generate reference panel samples are also possible. For example, the computing server 130 may collect a set of samples and gradually filter and refine the samples until high-quality reference panel samples are selected. For example, a candidate reference panel sample may be selected from an individual whose recent ancestors are born at a certain birthplace. The computing server 130 may also draw sequence data from the Human Genome Diversity Project (HGDP). Various candidates may be manually screened based on their family trees, relatives' birth location, and other quality control. Principal component analysis may be used to create clusters of genetic data of the candidates. Each cluster may represent an ethnicity. The predictions of the ethnicity of those candidates may be compared to the ethnicity information provided by the candidates to perform further screening.

The ethnicity estimation engine 245 estimates the ethnicity composition of a genetic dataset of a target individual. The genetic datasets used by the ethnicity estimation engine 245 may be genotype datasets or haplotype datasets. For example, the ethnicity estimation engine 245 estimates the ancestral origins (e.g., ethnicity) based on the individual's genotypes or haplotypes at the SNP sites. To take a simple example of three ancestral populations corresponding to African, European and Native American, an admixed user may have nonzero estimated ethnicity proportions for all three ancestral populations, with an estimate such as [0.05, 0.65, 0.30], indicating that the user's genome is 5% attributable to African ancestry, 65% attributable to European ancestry and 30% attributable to Native American ancestry. The ethnicity estimation engine 245 generates the ethnic composition estimate and stores the estimated ethnicities in a data store of computing server 130 with a pointer in association with a particular user.

In some embodiments, the ethnicity estimation engine 245 divides a target genetic dataset into a plurality of windows (e.g., about 1000 windows). Each window includes a small number of SNPs (e.g., 300 SNPs). The ethnicity estimation engine 245 may use a directed acyclic graph model to determine the ethnic composition of the target genetic dataset. The directed acyclic graph may represent a trellis of an inter-window hidden Markov model (HMM). The graph includes a sequence of a plurality of node groups. Each node group, representing a window, includes a plurality of nodes. The nodes represent different possibilities of labels of genetic communities (e.g., ethnicities) for the window. A node may be labeled with one or more ethnic labels. For example, a level includes a first node with a first label representing the likelihood that the window of SNP sites belongs to a first ethnicity and a second node with a second label representing the likelihood that the window of SNPs belongs to a second ethnicity. Each level includes multiple nodes so that there are many possible paths to traverse the directed acyclic graph.

The nodes and edges in the directed acyclic graph may be associated with different emission probabilities and transition probabilities. An emission probability associated with a node represents the likelihood that the window belongs to the ethnicity labeling the node given the observation of SNPs in the window. The ethnicity estimation engine 245 determines the emission probabilities by comparing SNPs in the window corresponding to the target genetic dataset to corresponding SNPs in the windows in various reference panel samples of different genetic communities stored in the reference panel sample store 240. The transition probability between two nodes represents the likelihood of transition from one node to another across two levels. The ethnicity estimation engine 245 determines a statistically likely path, such as the most probable path or a probable path that is at least more likely than 95% of other possible paths, based on the transition probabilities and the emission probabilities. A suitable dynamic programming algorithm such as the Viterbi algorithm or the forward-backward algorithm may be used to determine the path. After the path is determined, the ethnicity estimation engine 245 determines the ethnic composition of the target genetic dataset by determining the label compositions of the nodes that are included in the determined path. U.S. Pat. No. 10,558,930, entitled “Local Genetic Ethnicity Determination System,” granted on Feb. 11, 2020, describes example embodiments of ethnicity estimation.

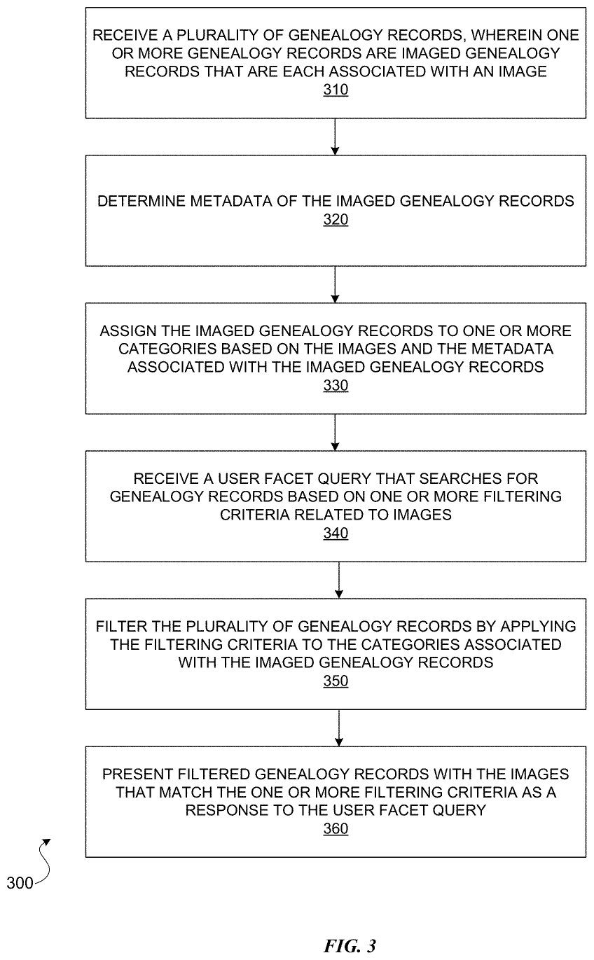

The front-end interface 250 displays various results determined by the computing server 130. The results and data may include the IBD affinity between a user and another individual, the community assignment of the user, the ethnicity estimation of the user, phenotype prediction and evaluation, genealogy data search, family tree and pedigree, relative profile and other information. The front-end interface 250 may allow users to manage their profile and data trees (e.g., family trees). The users may view various public family trees stored in the computing server 130 and search for individuals and their genealogy data via the front-end interface 250. The computing server 130 may suggest or allow the user to manually review and select potentially related individuals (e.g., relatives, ancestors, close family members) to add to the user's data tree. The front-end interface 250 may also allow a user to search for various genealogy records, such as conducting an image facet search that is described in further detail below in associated with FIG. 3 through FIG. 9B. The front-end interface 250 may be a graphical user interface (GUI) that displays various information and graphical elements. The front-end interface 250 may take different forms. In one case, the front-end interface 250 may be a software application that can be displayed on an electronic device such as a computer or a smartphone. The software application may be developed by the entity controlling the computing server 130 and be downloaded and installed on the client device 110. In another case, the front-end interface 250 may take the form of a webpage interface of the computing server 130 that allows users to access their family tree and genetic analysis results through web browsers. In yet another case, the front-end interface 250 may provide an application program interface (API).

The tree management engine 260 performs computations and other processes related to users' management of their data trees such as family trees. The tree management engine 260 may allow a user to build a data tree from scratch or to link the user to existing data trees. In some embodiments, the tree management engine 260 may suggest a connection between a target individual and a family tree that exists in the family tree database by identifying potential family trees for the target individual and identifying one or more most probable positions in a potential family tree. A user (target individual) may wish to identify family trees to which he or she may potentially belong. Linking a user to a family tree or building a family may be performed automatically, manually, or using techniques with a combination of both. In an embodiment of an automatic tree matching, the tree management engine 260 may receive a genetic dataset from the target individual as input and search related individuals that are IBD-related to the target individual. The tree management engine 260 may identify common ancestors. Each common ancestor may be common to the target individual and one of the related individuals. The tree management engine 260 may in turn output potential family trees to which the target individual may belong by retrieving family trees that include a common ancestor and an individual who is IBD-related to the target individual. The tree management engine 260 may further identify one or more probable positions in one of the potential family trees based on information associated with matched genetic data between the target individual and DNA test takers in the potential family trees through one or more machine learning models or other heuristic algorithms. For example, the tree management engine 260 may try putting the target individual in various possible locations in the family tree and determine the highest probability position(s) based on the genetic datasets of the target individual and other DNA test takers in the family tree and based on genealogy data available to the tree management engine 260. The tree management engine 260 may provide one or more family trees from which the target individual may select. For a suggested family tree, the tree management engine 260 may also provide information on how the target individual is related to other individuals in the tree. In a manual tree building, a user may browse through public family trees and public individual entries in the genealogy data store 200 and individual profile store 210 to look for potential relatives that can be added to the user's family tree. The tree management engine 260 may automatically search, rank, and suggest individuals for the user conduct manual reviews as the user makes progress in the front-end interface 250 in building the family tree.

As used herein, “pedigree” and “family tree” may be interchangeable and may refer to a family tree chart or pedigree chart that shows, diagrammatically, family information, such as family history information, including parentage, offspring, spouses, siblings, or otherwise for any suitable number of generations and/or people, and/or data pertaining to persons represented in the chart. U.S. Patent Publication Application No., entitled “Linking Individual Datasets to a Database,” US2021/0216556, published on Jul. 15, 2021, describes example embodiments of how an individual may be linked to existing family trees.

### Example Image Faceting Process and Record Facet Search

FIG. 3 is a flowchart depicting an example process 300 for providing a record facet search based on image faceting, in accordance with some embodiments. The process 300 may be performed by a computing device, such as the computing server 130. The process 300 may be embodied as a software algorithm that may be stored as computer instructions that are executable by one or more processors. The instructions, when executed by the processors, cause the processors to perform various steps in the process 300. One or more steps in the process 300 may be skipped, added, or changed in various embodiments. While the process 300 and related discussion in this disclosure are illustrated using genealogy records as examples, the process 300 and various embodiments described in this disclosure may also be used for other types of data records with images without the loss of generality. The categories, metadata, fields, and image types that are specific to genealogy records may be replaced with corresponding things in other types of data records in other embodiments.

The computing server 130 may receive 310 multiple genealogy records. Examples of types of genealogy records are discussed above in association with the discussions of the genealogy data store 200, the individual profile store 210, and the tree management engine 260. The genealogy records may belong to the same collection (e.g., census records from the same year, birth records from the same county government) or multiple collections. A genealogy record may be a single record or a composite record. For example, a single record may be a single entry for an individual in a historical database such as a birth record database. A composite record may be a set of entries from different sources that are compiled together as those entries belong to the same individual. Some of the genealogy records may be imaged genealogy records that are each associated with an image. For example, a genealogy record may be an individual profile or record (e.g., a composite profile, a marriage record, a military record) that has an image of the individual. A genealogy record may be a tombstone record that has a photo of the tombstone. A genealogy record may be a document record that has an image of the outline of the document. A genealogy record may be a community record that shows a photo of a landscape in the community. Additional examples of genealogy records are also possible. A genealogy record may be a standalone image unaccompanied by other documents.

The computing server 130 may determine 320 metadata of the imaged genealogy records. The metadata may be inherent or intrinsic with the images (e.g., when the image was taken, when the genealogy record was generated, which individual(s), place(s), and/or thing(s) correspond to or are contained within the record or image, and/or the location associated with the genealogy record). The determination may be simply an extraction of metadata that comes with the record. The metadata may be associated with the image directly or associated with the genealogy record.

In some embodiments, the determination of the metadata may involve the computing server 130 generating the metadata by analyzing the images. The metadata may be determined using a classification model or any other suitable machine learning model to extract captions, contextual information, and/or other image features of the images. For example, an image recognition model may assign metadata based on actions recognized by the model, such as “woman holding baby,” “girl in a field,” etc. Likewise, if an image faceting category includes, for example, “scenery,” the model may assign metadata such as “urban scenery” and “rural scenes” and further detailed metadata such as “cityscape” and “mountains.”

The computing server 130 may assign 330 the imaged genealogy records to one or more categories based on the images and the metadata associated with the imaged genealogy records. The assignment may include assigning a category tag indicating that a record belongs to a category and optionally a subcategory. The category tag may serve as the indexes of the genealogy records and/or one of the metadata fields. The category tag may be hierarchical and be defined based on a predefined or dynamic taxonomy of images used by the computing server 130. In some embodiments, the assignment of categories may also involve storing genealogy records of the same category and/or subcategory under the same or similar storage location for fast data retrieval. In some embodiments, the images and metadata may be classified according to predetermined faceting dimensions. The images may be assigned based on the characteristics of the images in each of the faceting dimensions. The labels or classifications may be stored in a database with the records. In some embodiments, the records and corresponding labels can be collated into a specific collection stored on the database, e.g., a “Public member photos” collection.

In some embodiments, the assignments may be carried out using one or more models or translation algorithms. The translation algorithms may be rule-based and specific to a particular collection of images (e.g., images already preprocessed according to step 320 and are associated with metadata). The translation algorithm may be any suitable model for consolidating classified images into desired faceting dimensions. In some embodiment, machine learning models may also be used. For example, a classification model is trained to classify images directly to image-faceting dimensions and categories such that a translation algorithm is not used.

The computing server 130 may advantageously facilitate accurate and automated image faceting by utilizing one or more instances of metadata about images in genealogy records. In some embodiments, a machine learning algorithm, such as a classification model, is utilized to provide one or more classifications and optionally one or more subclassifications depending on a corresponding one or more of the classifications to an image in a record. The methods and components utilized, for example, in U.S. Pat. No. 10,318,846, granted on Jun. 11, 2019, which is hereby incorporated in its entirety by reference, may be utilized.

For example, various approaches related to one or more convolutional neural networks (“CNN”) may be used. In some embodiments, in a first approach, a CNN is trained on millions of labeled historical documents so as to classify documents into groups. In some embodiments, in a second approach, an existing CNN model, such as one trained on ImageNet, is used in conjunction with a feature classifier that is iteratively trained by manually labeling a small number of historical images (generally less than 100) to bootstrap the training of the feature classifier. In some embodiments, in a third approach, a CNN is trained on labeled historical documents and then is used in conjunction with a feature classifier that is iteratively trained by manually labeling a small number of historical images from the domain of a single project. A small number of historical images that are manually labeled are used to “bootstrap” the training of the feature classifier. These three approaches to classifying historical images each offer advantages and disadvantages and may be used in conjunction with or alternative to each other. The first approach and the third approach may achieve more accurate labeling results than the second approach, however, the associated time and cost of manually labeling millions of historical documents may be prohibitive. The second approach may achieve slightly less accurate labeling results in certain circumstances, but is faster and much less expensive than the first approach.

Some of the labels that CNN may apply include, but are not limited to: photo, people, drawing, painting, portrait, candid, one person, children, multiple people, elderly, people at home, woman holding baby, baby, man on a horse, girl in the field, worker in a factory, sunset with horse-drawn carriage, man in a red shirt with umbrella, as well as objects or locations such as scenic, cityscape, landscape, river, mountains, house, school, cemetery, hospital, gravestone, animals, combinations and/or alterations thereof, or any other suitable label or classification. The labels define, in some embodiments, classifications and corresponding subclassifications. In other embodiments, the labels are not arranged hierarchically. The labels constitute metadata for the associated images.

Other categories may include clipart, document, people, person, tombstones, proposed sports classes, vehicles, buildings, historical, combinations thereof, or others.

In some embodiments, the classification model is configured to assign a label with a degree of confidence, such as a confidence interval representing the confidence of the model that the image truly corresponds to the assigned label. The confidence interval may range from 0.0 to 1.0.

The above-described method of applying labels and classifications to images is not limited to the types of genealogy records that contain historical records by any means, but rather may extend to other types of genealogy records such as user-generated content (“UGC”), existing databases, or any other suitable source of data, such as user-generated images. In family history embodiments, the above-mentioned classifications and subclassifications or other suitable classifications/labels may be applied to images obtained from a user's family tree, e.g., user-provided images of a historical person or ancestor.

In some embodiments, the images received and categorized for image faceting include externally applied metadata that may likewise be used for categorizing the images.

In some embodiments, the images may be assigned into categories and subcategories to facilitate image faceting according to the categories and subcategories. For example, the computing server 130 may present the user with an option to image facet according to at least a first category of “people” and at least corresponding subcategories of “groups” and “individuals,” the received images being consolidated into “groups” and “individuals” subcategories using an algorithm.

In addition to or alternative to a machine learning model, a translation algorithm may also be used. In some embodiments, a translation algorithm may be a rule-based translation that receives the classifications and any associated subclassifications defining the metadata of the received images and directing the images with suitable classifications into desired categories and subcategories. For example, in some embodiments, the rule-based translation algorithm directs an image with the label “woman holding baby” into the category “people” and into the subcategory “groups,” and an image with the label “girl in field” into the category “people” and into the subcategory “individuals.” Likewise, if an image faceting category includes, for example, “scenery,” and corresponding subcategories “urban scenery” and “rural scenes,” then the rule-based translation algorithm directs an image with the label “cityscape” into the “urban scenery” subcategory and an image with the label “mountains” into the “rural scenes” subcategory.

In some embodiments, to ensure accuracy, the rule-based translation algorithm may be configured to receive only images with a confidence interval above a predetermined threshold, for example above 0.9. Any suitable threshold may be used. The predetermined threshold may be dynamic in some embodiments and adjusted relative to user feedback; for example, the threshold may be raised if certain collections or classification models are returning or known to return inaccurate results. The threshold may be determined based on the classification or other machine learning model used and/or the collection of images from which the images are received.

While the above examples have been provided, it will nevertheless be appreciated that any suitable category and associated subcategories may be used and that the rule-based algorithm may receive and cooperate with any suitable labels. Categories may further include “resting places,” “documents and screenshots,” “community and geography,” “transportation and travel,” and “family symbols and art.” The category “resting places” may include subcategories “cemeteries” and “tombstones,” for example. The category “documents and screenshots” may include subcategories “documents” and “screenshots.” The category “community and geography” may include the subcategories “buildings,” “landscapes,” and “maps,” for example. The category “transportation and travel” may include the subcategories “ships,” “planes,” “cars,” and “trains,” for example. The category “family symbols and art” may include the subcategories “family symbols,” such as family crests, “clipart,” and “other artwork.” The above-described taxonomy is merely exemplary and by no means limiting.

While a rule-based translation is described, it will also be appreciated that any suitable method of determining a categorization of a received image is contemplated within the disclosure. For example, a machine learning model configured and trained for extracting context and/or narrative from a captioned image, such as from a newspaper, yearbook, or otherwise, may be used to automatically assign the received captioned image to a category and/or subcategory without the intermediation of a distinct classification model as described above.

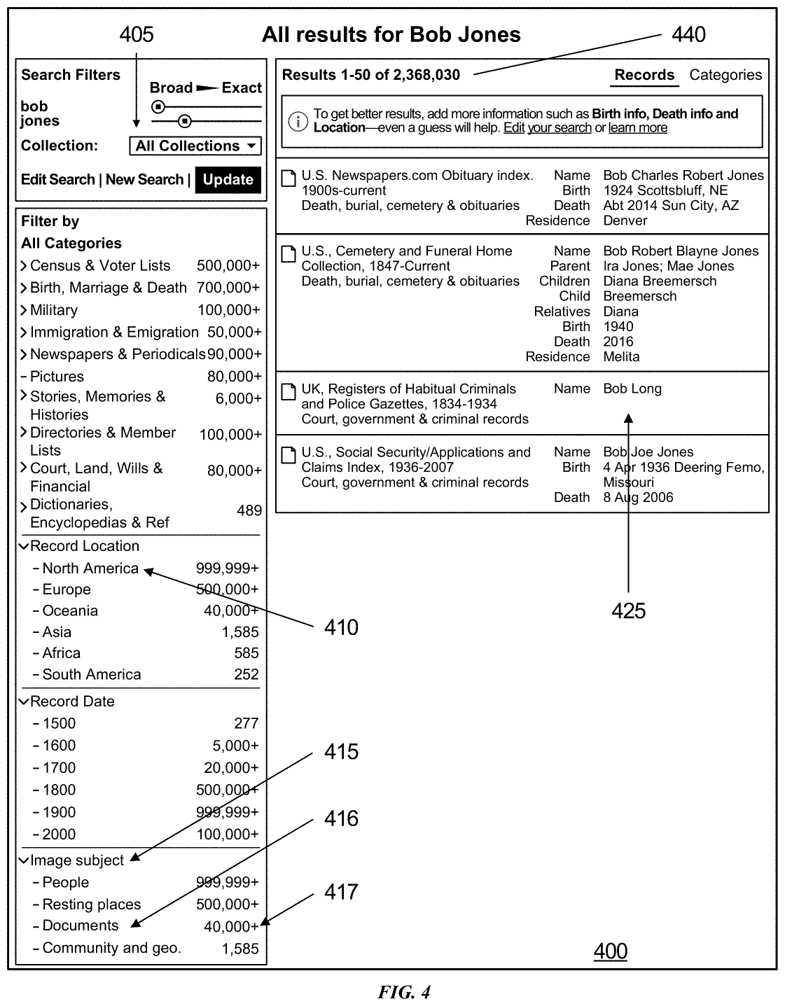

The computing server 130 may receive 340 a user facet query that searches for genealogy records based on one or more filtering criteria related to images. For example, the filtering criteria may correspond to the categories and subcategories. FIG. 4 through FIG. 9B show various examples of front-end user interface and filtering criteria from which a user may select during a facet query. In some embodiments, a query may also include a keyword search. The computing server 130 may maintain one or more lookup tables to map keywords to different categories and subcategories. The filtering criteria may be presented as a scale (year range, date range), checkboxes, hierarchical trees, and other suitable forms. The computing server 130 may filter 350 the plurality of genealogy records by applying the filtering criteria to the categories associated with the imaged genealogy records. For example, the filtering criteria may match certain categories and subcategories. The computing server 130 may retrieve genealogy records that have the category tags matching those filtering criteria. The computing server 130 may present 360 filtered genealogy records with the images that match one or more filtering criteria as a response to the user facet query. Examples of the query results are illustrated in FIG. 4 through FIG. 9B.

### Example Graphical User Interfaces

Turning to FIG. 4, an interface 400 of a search system is shown and described. The interface 400 includes, for example, search filters 405, search facets 410, and image facets 415. The number of results 440 from a keyword-only search are displayed, and individual results 425 are listed in order, for example, of relevance. The image facets 415 include categories 416 that a user may select from, each category 416 having an associated result number 417. So many results 440 are returned that a user would have to navigate through dozens of pages of results to identify instances of desired results, such as images of a desired ancestor.

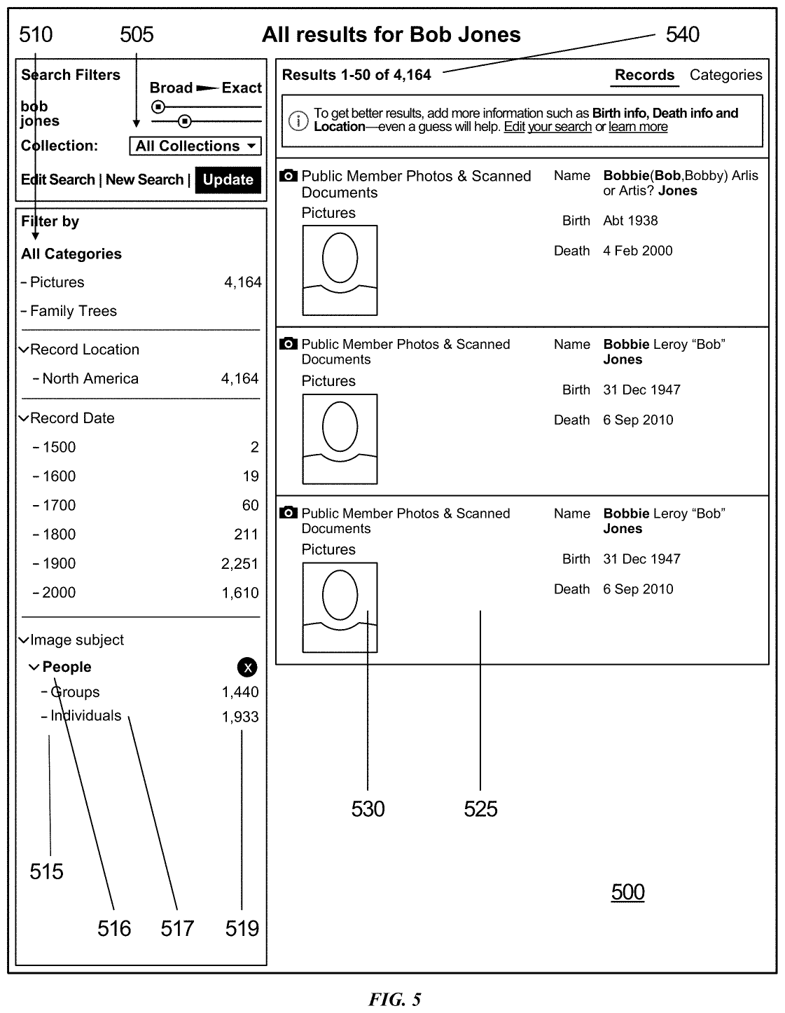

Turning to FIG. 5, an interface 500 of the search system that has been filtered using image faceting according to “people” is shown and described. The interface 500 likewise has search filters 505 and search facets 510, which may include image facets 515. The image facets 515 are broken out into subcategories 517 of the selected category 516. In this embodiment, the category “people” has been selected and subcategories “groups” and “individuals” are available for a user to select. The associated result number 519 for each subcategory facilitates a user further drilling down on desired results, for example only those records which have images of groups of people. The number of results 540 has been reduced by four orders of magnitude (from nearly three million results to just over 3,000) and associated images 530 are shown in each result 525.

The order of relevance determined in the original search results may be retained or preserved among the results 525 that have been so faceted, such that any result 525 that was originally determined to be of most relevance to the original query is ranked higher than other results, even if such results were disparately returned in the original result set. However, an order specific to image faceting operation may alternatively be imposed, such as ranking the results returned, for example, based on the confidence threshold for the images themselves, the quality of the images, or any other metric.

In a specific family history embodiment, users upload photos as UGC directly to virtual family tree nodes or profiles representing individual persons. A collection of images representing UGC is collected from the sum total of user family trees. Simultaneously or subsequently, the images may be assessed using a classification model or other model as described above and annotated with metadata including labels, for example “woman holding a baby” or “portrait.” The images from the family tree are then received or gathered from a specific UGC collection and/or from a repository of classified images to consolidate into faceting categories and subcategories such that the records or images are filterable through image faceting operations described herein. The rule-based translation algorithm is advantageously adapted to receive images sourced from highly disparate and diverse collections of images with highly divergent sets of labels, tags, metadata, and other classifications.

For example, the “groups” image faceting category may include classifications identified automatically using the classification model such as “people_unknown,” “people_art,” “people_art_portrait,” “people_photo-baby,” “people_photo-candid,” “people_photo-posed,” or “people_photo-scene,” for example. This is merely exemplary and it will be understood that any taxonomy of categories, subcategories, classifications, and subclassifications may be used.

Any number or variety and combination of collections and sources of images, including images with entirely different labels and metadata, may be simultaneously or sequentially organized using the rule-based translation into the faceting dimensions as described above. The image faceting embodiments advantageously utilize images from numerous sources, collections, and processes such that an increased number of records are available for image-faceted searching by a user. Sources of images include UGC, yearbooks, newspapers, postcards, catalogs (e.g. Sears, Roebuck, and Co. catalogs), military records, artwork and photographs, marriage, family, and death records, government records, family history books, combinations thereof, and any other collections or sources as suitable.

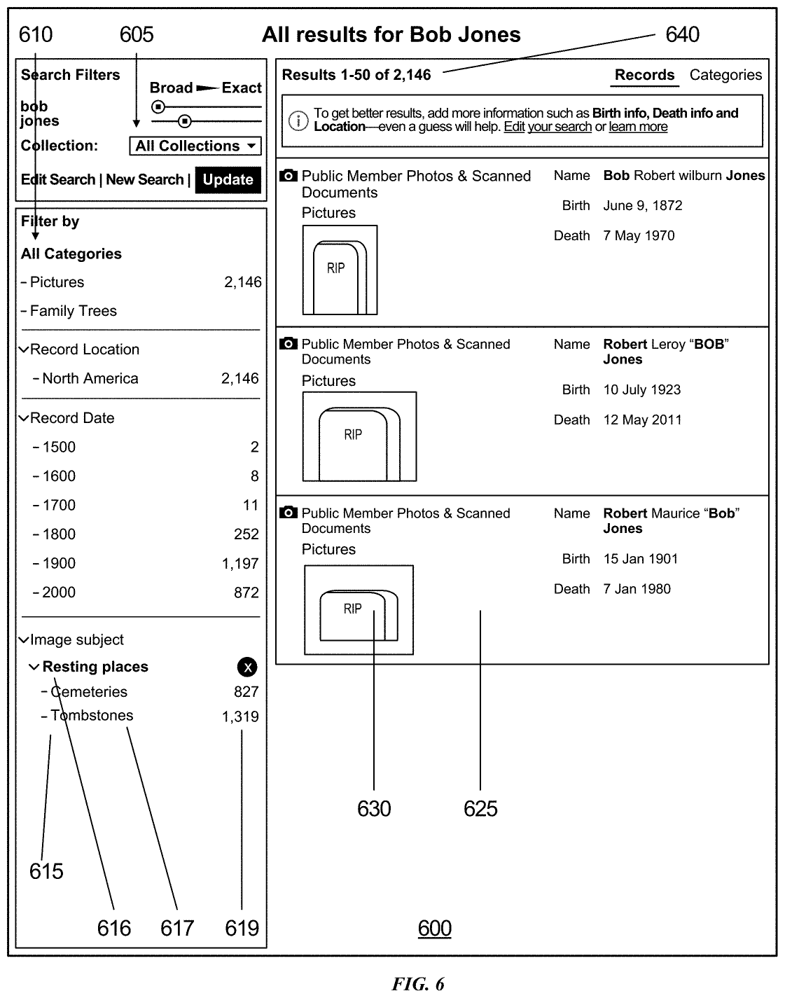

Turning to FIG. 6, an interface 600 of the search system that has been filtered using image faceting according to “resting place” is shown and described. The interface 600 includes search filters 605 and search facets 610, which may include the image facets 615. The image facets 615 are broken out into subcategories 617 of the selected category 616. “Resting places” has been selected and the subcategories “cemeteries” and “tombstones” have been broken out for a user to select, with the number of results 619 available for a user to further direct, e.g. narrow, their search. The results 625 are filtered to those results which include images 630 associated with “resting places.” The number of results 640 has likewise been reduced by four orders of magnitude, dramatically simplifying and expediting a user's review of the search results.

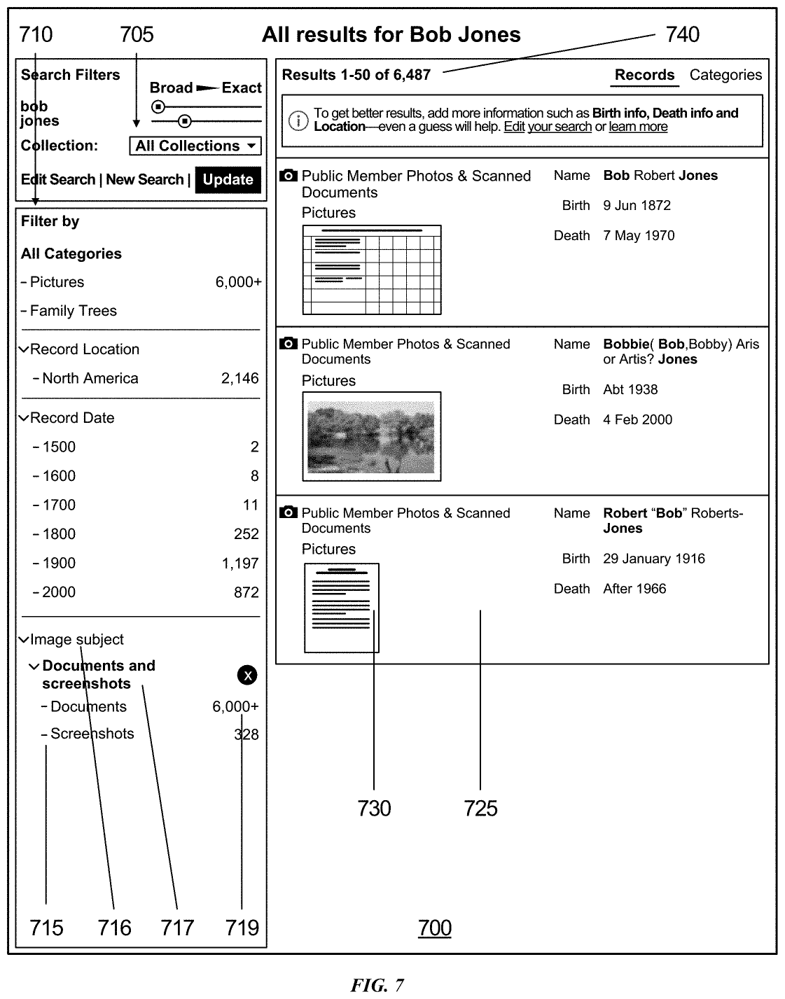

Turning to FIG. 7, an interface 700 of the search system that has been filtered using image faceting according to “Documents and screenshots” is shown and described. The interface 700 includes search filters 705 and search facets 710, which may include image facets 715. The image facets 715 are broken out into subcategories 717 of the selected category 716. “Documents and screenshots” field has been broken out into the subcategories “documents” and “screenshots,” with the number of results 719 displayed adjacent to the subcategories 717. The results 725 are shown with the associated images 730. Again, the results 740 have been reduced by orders of magnitude.

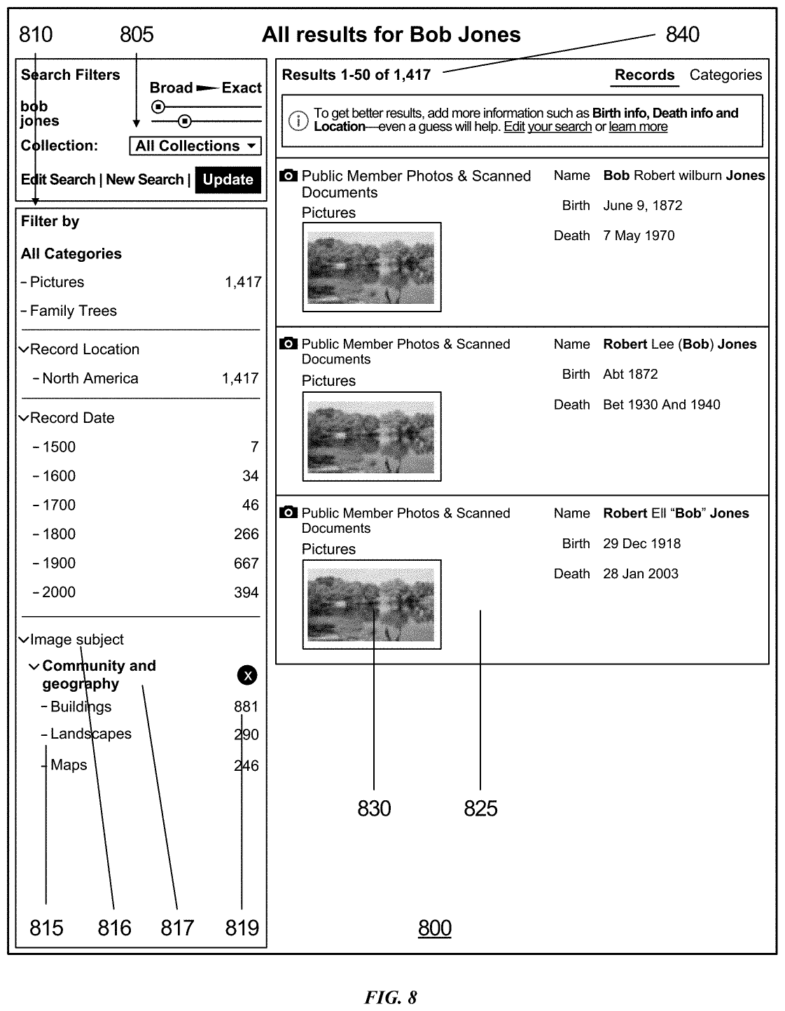

Turning to FIG. 8, an interface 800 of the search system that has been filtered using image faceting according to “Community and geography” is shown and described. The interface 800 includes search filters 805 and search facets 810, which may include image facets 815. The image facets 815 are broken out into subcategories 817 of the selected category 816. “Community and geography” field has been broken out into the subcategories “buildings,” “landscapes,” and “maps,” with the number of corresponding results 819 displayed adjacent to the subcategories 817. The results 825 are shown with the associated images 830. Again, the results 840 have been reduced by orders of magnitude.

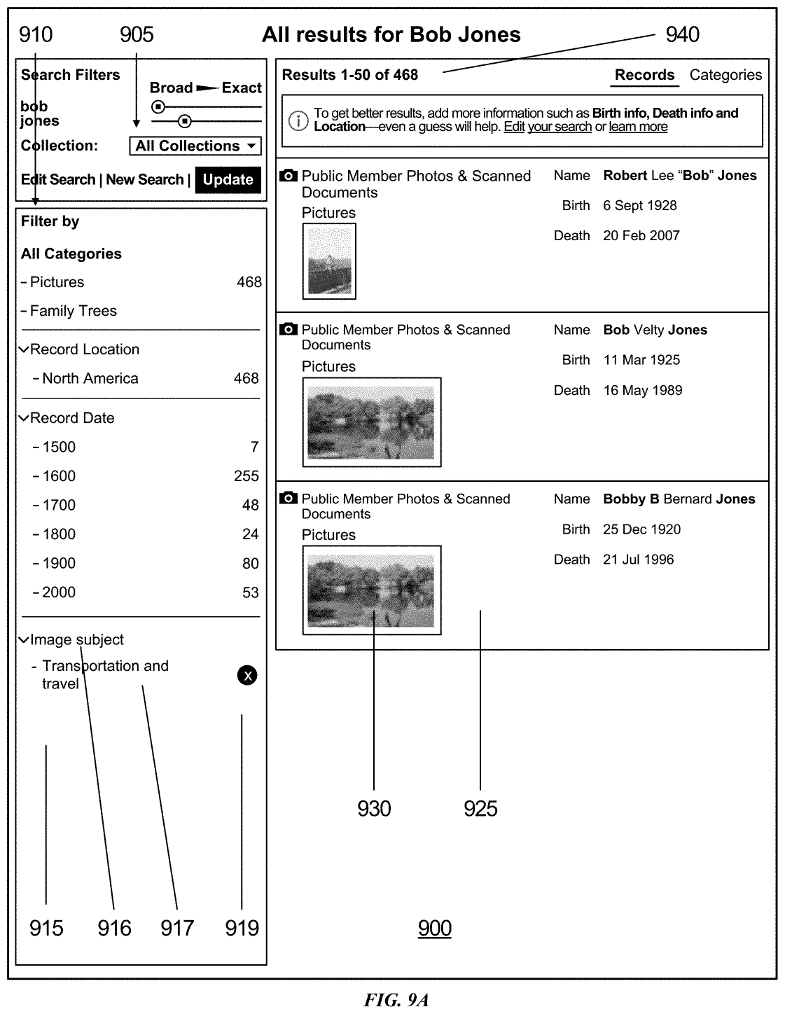

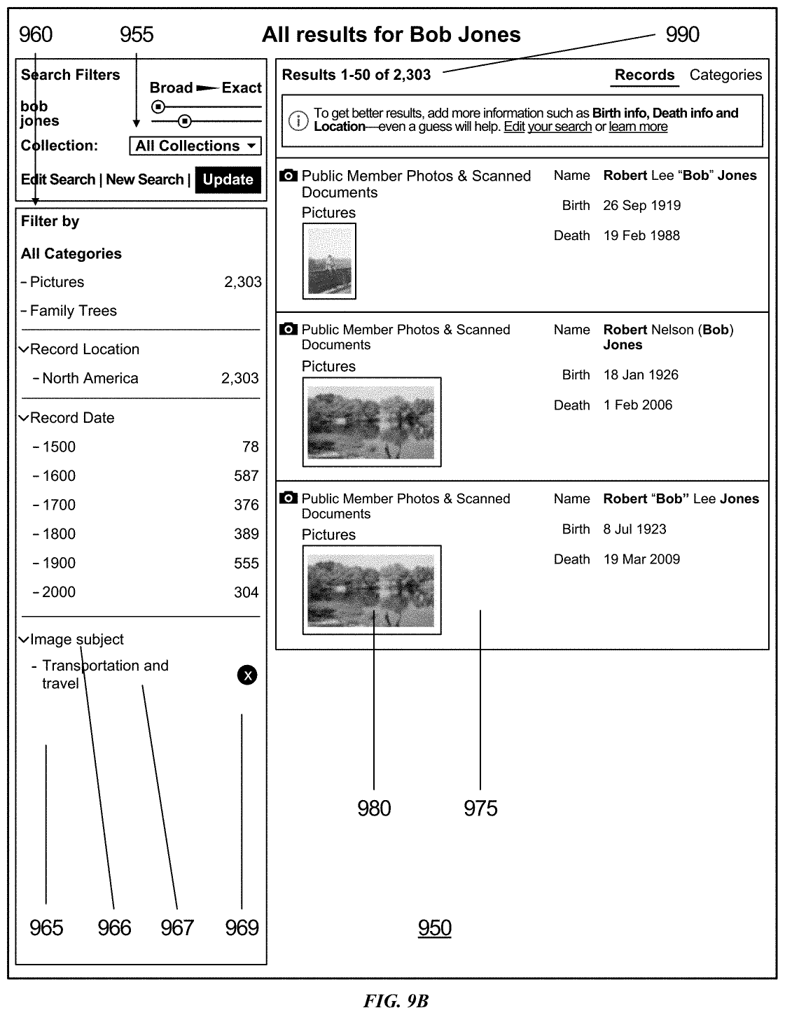

Turning to FIG. 9A, an interface 900 of the search system that has been filtered using image faceting according to “Transportation and travel” is shown and described. The interface 900 includes search filters 905 and search facets 910, which may include image facets 915. The image facets 915 are broken out into subcategories 917 of the selected category 916. “Transportation and travel” may not be further broken out (as shown), but in some embodiments could be broken out into the subcategories “ships,” “cars,” “planes,” and “trains,” with the number of corresponding results 919 displayed adjacent to the subcategories 917. The results 925 are shown with the associated images 930. Again, the results 940 have been reduced by orders of magnitude.

Turning to FIG. 9B, an interface 950 of the search system that has been filtered using image faceting according to “family symbols and art” is shown and described. The interface 950 includes search filters 955 and search facets 960, which may include image facets 965. The image facets 965 are broken out into subcategories 967 of the selected category 966. “Family subjects and art” is broken out into the subcategories “family symbols,” “clipart,” and “other artwork,” with the number of corresponding results 969 displayed adjacent to the subcategories 967. The results 975 are shown with the associated images 980. Again, the results 990 have been reduced by orders of magnitude.

### Computing Machine Architecture

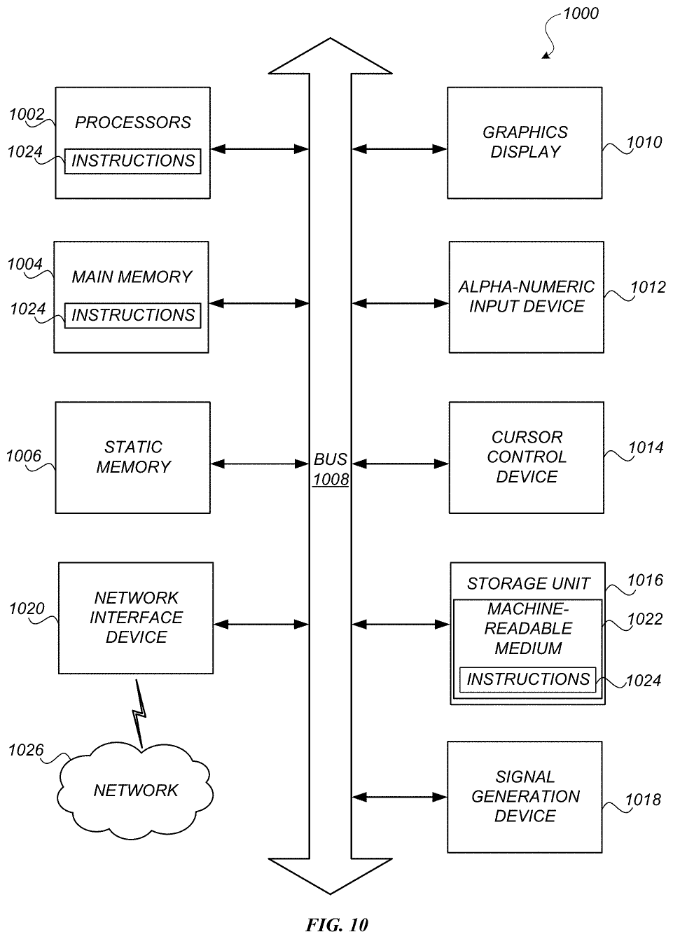

FIG. 10 is a block diagram illustrating components of an example computing machine that is capable of reading instructions from a computer-readable medium and execute them in a processor (or controller). A computer described herein may include a single computing machine shown in FIG. 10, a virtual machine, a distributed computing system that includes multiple nodes of computing machines shown in FIG. 10, or any other suitable arrangement of computing devices.

By way of example, FIG. 10 shows a diagrammatic representation of a computing machine in the example form of a computer system 1000 within which instructions 1024 (e.g., software, source code, program code, expanded code, object code, assembly code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 10 may correspond to any software, hardware, or combined components shown in FIGS. 1 and 2, including but not limited to, the client device 110, the computing server 130, and various engines, interfaces, terminals, and machines shown in FIG. 2. While FIG. 10 shows various hardware and software elements, each of the components described in FIGS. 1 and 2 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 1024 that specify actions to be taken by that machine. Further, while only a single machine is illustrated, the term “machine” and “computer” may also be taken to include any collection of machines that individually or jointly execute instructions 1024 to perform any one or more of the methodologies discussed herein.

The example computer system 1000 includes one or more processors 1002 such as a CPU (central processing unit), a GPU (graphics processing unit), a TPU (tensor processing unit), a DSP (digital signal processor), a system on a chip (SOC), a controller, a state equipment, an application-specific integrated circuit (ASIC), a field-programmable gate array (FPGA), or any combination of these. Parts of the computing system 1000 may also include a memory 1004 that store computer code including instructions 1024 that may cause the processors 1002 to perform certain actions when the instructions are executed, directly or indirectly by the processors 1002. Instructions can be any directions, commands, or orders that may be stored in different forms, such as equipment-readable instructions, programming instructions including source code, and other communication signals and orders. Instructions may be used in a general sense and are not limited to machine-readable codes. One or more steps in various processes described may be performed by passing through instructions to one or more multiply-accumulate (MAC) units of the processors.

One and more methods described herein improve the operation speed of the processors 1002 and reduces the space required for the memory 1004. For example, the database processing techniques and machine learning methods described herein reduce the complexity of the computation of the processors 1002 by applying one or more novel techniques that simplify the steps in training, reaching convergence, and generating results of the processors 1002. The algorithms described herein also reduces the size of the models and datasets to reduce the storage space requirement for memory 1004.

The performance of certain operations may be distributed among more than one processor, not only residing within a single machine, but deployed across a number of machines. In some example embodiments, the one or more processors or processor-implemented modules may be located in a single geographic location (e.g., within a home environment, an office environment, or a server farm). In other example embodiments, one or more processors or processor-implemented modules may be distributed across a number of geographic locations. Even though in the specification or the claims may refer some processes to be performed by a processor, this should be construed to include a joint operation of multiple distributed processors.

The computer system 1000 may include a main memory 1004, and a static memory 1006, which are configured to communicate with each other via a bus 1008. The computer system 1000 may further include a graphics display unit 1010 (e.g., a plasma display panel (PDP), a liquid crystal display (LCD), a projector, or a cathode ray tube (CRT)). The graphics display unit 1010, controlled by the processors 1002, displays a graphical user interface (GUI) to display one or more results and data generated by the processes described herein. The computer system 1000 may also include alphanumeric input device 1012 (e.g., a keyboard), a cursor control device 1014 (e.g., a mouse, a trackball, a joystick, a motion sensor, or other pointing instruments), a storage unit 1016 (a hard drive, a solid-state drive, a hybrid drive, a memory disk, etc.), a signal generation device 1018 (e.g., a speaker), and a network interface device 1020, which also are configured to communicate via the bus 1008.

The storage unit 1016 includes a computer-readable medium 1022 on which is stored instructions 1024 embodying any one or more of the methodologies or functions described herein. The instructions 1024 may also reside, completely or at least partially, within the main memory 1004 or within the processor 1002 (e.g., within a processor's cache memory) during execution thereof by the computer system 1000, the main memory 1004 and the processor 1002 also constituting computer-readable media. The instructions 1024 may be transmitted or received over a network 1026 via the network interface device 1020.

While computer-readable medium 1022 is shown in an example embodiment to be a single medium, the term “computer-readable medium” should be taken to include a single medium or multiple media (e.g., a centralized or distributed database, or associated caches and servers) able to store instructions (e.g., instructions 1024). The computer-readable medium may include any medium that is capable of storing instructions (e.g., instructions 1024) for execution by the processors (e.g., processors 1002) and that cause the processors to perform any one or more of the methodologies disclosed herein. The computer-readable medium may include, but not be limited to, data repositories in the form of solid-state memories, optical media, and magnetic media. The computer-readable medium does not include a transitory medium such as a propagating signal or a carrier wave.

### ADDITIONAL CONSIDERATIONS

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Any feature mentioned in one claim category, e.g. method, can be claimed in another claim category, e.g. computer program product, system, storage medium, as well. The dependencies or references back in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject matter may include not only the combinations of features as set out in the disclosed embodiments but also any other combination of features from different embodiments. Various features mentioned in the different embodiments can be combined with explicit mentioning of such combination or arrangement in an example embodiment or without any explicit mentioning. Furthermore, any of the embodiments and features described or depicted herein may be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcode, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In some embodiments, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed in the specific order claimed or described in the disclosure. Some steps may be performed before others even though the other steps are claimed or described first in this disclosure. Likewise, any use of (i), (ii), (iii), etc., or (a), (b), (c), etc. in the specification or in the claims, unless specified, is used to better enumerate items or steps and also does not mandate a particular order.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A. In claims, the use of a singular form of a noun may imply at least one element even though a plural form is not used.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

The following applications are incorporated by reference in their entirety for all purposes: (1) U.S. Pat. No. 10,679,729, entitled “Haplotype Phasing Models,” granted on Jun. 9, 2020, (2) U.S. Pat. No. 10,223,498, entitled “Discovering Population Structure from Patterns of Identity-By-Descent,” granted on Mar. 5, 2019, (3) U.S. Pat. No. 10,720,229, entitled “Reducing Error in Predicted Genetic Relationships,” granted on Jul. 21, 2020, (4) U.S. Pat. No. 10,558,930, entitled “Local Genetic Ethnicity Determination System,” granted on Feb. 11, 2020, (5) U.S. Pat. No. 10,114,922, entitled “Identifying Ancestral Relationships Using a Continuous Stream of Input,” granted on Oct. 30, 2018, and (6) U.S. Patent Publication Application No., entitled “Linking Individual Datasets to a Database,” US2021/0216556, published on Jul. 15, 2021.

What is claimed is:

1. A computer-implemented method, comprising:
receiving a plurality of genealogy records, wherein one or more genealogy records of the plurality of genealogy records are imaged genealogy records that are each associated with an image;
determining metadata associated with the imaged genealogy records;
assigning the imaged genealogy records to one or more categories based on the images and the metadata associated with the imaged genealogy records;
receiving a user facet query that searches for genealogy records based on one or more filtering criteria related to the images;
filtering the plurality of genealogy records by applying the one or more filtering criteria to the one or more categories associated with the imaged genealogy records; and
presenting filtered genealogy records with the images that match the one or more filtering criteria as a response to the user facet query.

2. The computer-implemented method of claim 1, wherein the metadata associated with the imaged genealogy records are data that inherent in the genealogy records.

3. The computer-implemented method of claim 1, wherein the metadata associated with the imaged genealogy records are image features that are extracted by a machine learning model.

4. The computer-implemented method of claim 1, wherein assigning the imaged genealogy records to one or more categories comprises applying a machine learning model to classify the image associated with the imaged genealogy records.

5. The computer-implemented method of claim 4, wherein the machine learning model comprises a convolutional neural network.

6. The computer-implemented method of claim 1, wherein assigning the imaged genealogy records to one or more categories comprises applying a translation algorithm.

7. The computer-implemented method of claim 1, wherein assigning the imaged genealogy records to one or more categories is based on one or more image facets, each facet associated with a characteristic of the image associated with an imaged genealogy record.

8. The computer-implemented method of claim 1, wherein assigning the imaged genealogy records to one or more categories comprises assigning the imaged genealogy records with one or more category tags, wherein a category tag indicates that a record belongs to a category or a subcategory.

9. The computer-implemented method of claim 1, wherein the plurality of genealogy records comprises individual records, tombstone records, document records, and community records.

10. A system, comprising:
a graphical user interface presented at a user device, the graphical user interface configured to receive a user facet query that searches for genealogy records based on one or more filtering criteria related to images; and
a computing server in communication with the graphical user interface, the computing server comprising one or more processors and memory, the memory configured to store code comprising instructions, wherein the instructions, when executed by the one or more processors, cause the one or more processors to perform steps comprising:
receiving a plurality of genealogy records, wherein one or more genealogy records of the plurality of genealogy records are imaged genealogy records that are each associated with an image;
determining metadata associated with the imaged genealogy records;
assigning the imaged genealogy records to one or more categories based on the images and the metadata associated with the imaged genealogy records;
receiving the user facet query from the graphical user interface;
filtering the plurality of genealogy records by applying the one or more filtering criteria to the one or more categories associated with the imaged genealogy records; and
presenting filtered genealogy records with the images that match the one or more filtering criteria as a response to the user facet query.

11. The system of claim 10, wherein the metadata associated with the imaged genealogy records are data that inherent in the genealogy records.

12. The system of claim 10, wherein the metadata associated with the imaged genealogy records are image features that are extracted by a machine learning model.

13. The system of claim 10, wherein assigning the imaged genealogy records to one or more categories comprises applying a machine learning model to classify the image associated with the imaged genealogy records.

14. The system of claim 13, wherein the machine learning model comprises a convolutional neural network.

15. The system of claim 10, wherein assigning the imaged genealogy records to one or more categories comprises applying a translation algorithm.

16. The system of claim 10, wherein assigning the imaged genealogy records to one or more categories is based on one or more image facets, each facet associated with a characteristic of the image associated with an imaged genealogy record.

17. The system of claim 10, wherein assigning the imaged genealogy records to one or more categories comprises assigning the imaged genealogy records with one or more category tags, wherein a category tag indicates that a record belongs to a category or a subcategory.

18. The system of claim 10, wherein the plurality of genealogy records comprises individual records, tombstone records, document records, and community records.

19. A non-transitory computer-readable medium configured to store code comprising instructions, wherein the instructions, when executed by one or more processors, cause the one or more processors to perform steps comprising:
receiving a plurality of genealogy records, wherein one or more genealogy records of the plurality of genealogy records are imaged genealogy records that are each associated with an image;
determining metadata associated with the imaged genealogy records;
assigning the imaged genealogy records to one or more categories based on the images and the metadata associated with the imaged genealogy records;
receiving a user facet query that searches for genealogy records based on one or more filtering criteria related to the images;
filtering the plurality of genealogy records by applying the one or more filtering criteria to the one or more categories associated with the imaged genealogy records; and
presenting filtered genealogy records with the images that match the one or more filtering criteria as a response to the user facet query.

20. The non-transitory computer-readable medium of claim 19, wherein assigning the imaged genealogy records to one or more categories comprises applying a machine learning model to classify the image associated with the imaged genealogy records.
